(19) United States
(12) Patent Application Publication
(10) Pub. No.: US 2014/0086371 A1
(43) Pub. Date: Mar. 27, 2014

(54) INTERFERENCE CANCELLATION APPARATUS AND RECEIVER

(71) Applicant: FUJITSU LIMITED, Kawasaki-shi (JP)

(72) Inventors: Baojin Li, Beijing (CN); Xin Wang, Beijing (CN)

(73) Assignee: FUJITSU LIMITED, Kawasaki-shi (JP)

(21) Appl. No.: 14/040,219

(22) Filed: Sep. 27, 2013

(30) Foreign Application Priority Data
Sep. 27, 2012 (CN) 201210374764.8

(51) Int. Cl. H04B 1/10

(52) U.S. Cl. CPC H04B 1/10
USPC 375/346

(57) ABSTRACT

The present invention provides an interference cancellation apparatus and receiver. The apparatus comprises: an interference cancellation unit configured to, based on preset granularities, seriatim perform interference cancellation on interference on common reference signals (CRSs) of interfering cells in each granularity; wherein in performing interference cancellation on the interference on the CRSs of the interfering cells in each granularity, the interference cancellation is performed based on metric values of the interfering cells and/or a predetermined order of interference cancellation. By using frequency selectivity of inter-cell interference, interference cancellation is performed on interference on CRSs of interfering cells in each granularity based on metric values of the interfering cells and/or a predetermined order of interference cancellation, thereby effectively performing interference cancellation, and increasing the accuracy of UE channel estimation and improving demodulation performance, even if the bandwidths of the cells are different.

### TECHNICAL FIELD

The present invention relates to the field of communications and, in particular to an interference cancellation apparatus and receiver.

### BACKGROUND ART

In heterogeneous networks (HetNet), the system capacity is increased or the coverage is extended by deploying low-power base stations, such as a pico/Micro base station, a femto base station, a remote radio head (RRH), and a relay node, etc., in a macro cell.

In comparison with a network where there is only a macro base station, there is more interference in a heterogeneous network. Currently, by configuring a macro base station with downlink almost blank subframes (ABSs), pico cell user equipment (pico UE) is schedule in the ABSs for downlink receiving, thereby avoiding downlink intense interference of the macro base station to the pico UE.

However, in the ABS scheme, the interference from a common reference signal (CRS) of a neighboring cell in the ABSs is still relatively intense, which affects detection of signaling and data. For example, the detection of a physical broadcast channel (PBCH), a physical control format indicator channel (PCFICH), a physical hybrid ARQ indicator channel (PHICH) and a physical downlink control channel (PDCCH) is affected, and the detection of a physical downlink shared channel (PDSCH) is affected; furthermore, such interference affects the measurement of UE; for example, the measurement of radio link monitor (RLM) based on a CRS/radio resource management (RRM), and the measurement of channel state information (CSI) based on a CRS, are affected.

Currently, in 3GPP, the serving cell to which UE belongs provides a neighboring cell list (an interfering cell list) to the UE via higher layer signaling. And after receiving the neighboring cell list, the UE may cancel interference of a CRS of the neighboring cell according to the information in the neighboring cell list.

However, in the implementation of the present invention, the inventors found following defects exist in the prior art: as there is no neighboring cell bandwidth information in the above list, when the bandwidths of the cells are different, the UE cannot effectively cancel the interference of the CRS of the neighboring cell according to the above information; and there is no effective method to cancel the above interference till now.

It should be noted that the above description of the background art is merely provided for clear and complete explanation of the present invention and for easy understanding by those skilled in the art. And it should not be understood that the above technical solution is known to those skilled in the art as it is described in the background art of the present invention.

### SUMMARY OF THE INVENTION

The embodiments of the present invention provide an interference cancellation apparatus and receiver, which perform interference cancellation to the CRS interference of an interfering cell in each granularity by using the frequency selectivity of inter-cell interference based on a preset granularity (all or part of bandwidths), a metric value of the interfering cell and/or a predefined order, thereby effectively performing interference cancellation, and increasing the accuracy of UE channel estimation and improving demodulation performance, even if the bandwidths of the cells are different.

According to an aspect of the embodiments of the present invention, there is provided an interference cancellation apparatus, comprising an interference cancellation unit configured to, based on preset granularities, seriatim perform interference cancellation on interference on common reference signals (CRSs) of interfering cells in each granularity; wherein in performing interference cancellation on the interference on the CRSs of the interfering cells in each granularity, the interference cancellation is performed based on metric values of the interfering cells and/or a predetermined order of interference cancellation;

in this case, the granularities denote a whole bandwidth or a part of the whole bandwidth, the number of corresponding granularities is N, N being an integer greater than or equal to 1, and the interfering cells are neighboring cells having interference on the serving cell to which a receiver belongs.

According to another aspect of the embodiments of the present invention, there is provided a receiver, comprising the interference cancellation apparatus as described above.

It can be seen from above that interference cancellation on interference on CRSs of interfering cells in each granularity is seriatim performed based on the preset granularities (whole or part of bandwidth), and for each granularity, the interference cancellation is performed based on metric values of the interfering cells and/or a predetermined order, thereby effectively performing interference cancellation, and increasing the accuracy of UE channel estimation and improving demodulation performance, even if the bandwidths of the cells are different.

With reference to the following description and drawings, the particular embodiments of the present invention are disclosed in detail, and the principle of the present invention and the manners of use are indicated. It should be understood that the scope of the embodiments of the present invention is not limited thereto. The embodiments of the present invention contain many alternations, modifications and equivalents within the spirits and scope of the terms of the appended claims.

Features that are described and/or illustrated with respect to one embodiment may be used in the same way or in a similar way in one or more other embodiments and/or in combination with or instead of the features of the other embodiments.

It should be emphasized that the term “comprises/comprising” when used in this specification is taken to specify the presence of stated features, integers, steps or components but does not preclude the presence or addition of one or more other features, integers, steps, components or groups thereof.

### BRIEF DESCRIPTION OF THE DRAWINGS

FIGS. 1A-1C are schematic diagrams of time-frequency structures of transmission signals of a serving cell, a colliding cell and a non-colliding cell within one resource block and one subframe, respectively;

FIG. 2 is a structural diagram of the interference cancellation apparatus of Embodiment 1 of the present invention;

FIG. 3 is a schematically structural diagram of a first processing unit in Embodiment 1 of the present invention;

FIG. 4 is a schematically structural diagram of a first processing unit in Embodiment 1 of the present invention;

FIG. 5 is a schematically structural diagram of a first processing unit in Embodiment 1 of the present invention;

FIG. 6 is a schematically structural diagram of a first calculating unit in Embodiment 1 of the present invention;

FIG. 7 is a schematic diagram of calculating interference and noise power by a CRS RE of a common CP based on port 0 in LTE/LTE-A;

FIGS. 8, 9 and 10 are schematic diagrams of calculating interference and noise power by a CRS RE of a common CP based on port 0 in LTE/LTE-A;

FIG. 11 is a schematically structural diagram of the receiver of Embodiment 2 of the present invention;

FIG. 12 is a flowchart of the interference cancellation method of Embodiment 3 of the present invention;

FIG. 13 is a flowchart of performing interference cancellation on the CRSs of an interfering cell in a granularity in Embodiment 4 of the present invention;

FIG. 14 is a flowchart of the interference cancellation method of Embodiment 5 of the present invention;

FIG. 15 is a schematically structural diagram of the interference cancellation apparatus of Embodiment 6 of the present invention; and

FIG. 16 is a flowchart of the interference cancellation method of Embodiment 8 of the present invention.

### DETAILED DESCRIPTION OF THE INVENTION

The foregoing and other features of the embodiments of the present invention will become apparent with reference to the drawings and the following description. These embodiments are illustrative only and are not intended to limit the present invention. For easy understanding of the principle and embodiments of the present invention by those skilled in the art, the principle of the embodiments of the present invention shall be described taking CRS interference cancellation of an LTE/LTE-A heterogeneous network as an example. However, it should be understood that the embodiments of the present invention are applicable to all the communication systems relating to CRS interference cancellation.

The embodiments of the present invention provide an interference cancellation method and apparatus, and a receiver.

The interference cancellation method comprises: seriatim performing interference cancellation on interference on common reference signals (CRSs) of interfering cells in each granularity by the receiver based on preset granularities; wherein in performing interference cancellation on the interference on the CRSs of the interfering cells in each granularity, the interference cancellation is performed based on metric values of the interfering cells and/or a predetermined order of interference cancellation.

The interference cancellation apparatus comprises: an interference cancellation unit configured to, based on preset granularities, seriatim perform interference cancellation on interference on common reference signals (CRSs) of interfering cells in each granularity; wherein in performing interference cancellation on the interference on the CRSs of the interfering cells in each granularity, the interference cancellation is performed based on metric values of the interfering cells and/or a predetermined order of interference cancellation.

In this case, the granularities denote a whole bandwidth or a part of the whole bandwidth, the number of corresponding granularities is N, N being an integer greater than or equal to 1, and the interfering cells are neighboring cells having interference on the serving cell to which a receiver belongs.

It can be seen from the above embodiment that for each predefined granularity, CRS interference cancellation may be performed independently based on metric values of the interfering cells and/or a predetermined order of interference cancellation. In this way, in performing CRS interference cancellation, frequency selectivity of interference is taken into consideration, thereby effectively performing interference cancellation, and increasing the accuracy of UE channel estimation and improving demodulation performance, even if the bandwidths of the cells are different.

In this embodiment, the size of the granularity may be determined according the number of resource blocks (RBs). For example, the size of a granularity is set as a multiple of the RBs, and there are total N granularities covering the whole bandwidth. One of the detailed manners of implementation is as shown in the formula given below:

$${N}^{′} = ⌊ \frac{Number of RBs contained in the whole bandwidth}{N} ⌋ ;$$

In the above formula, └·┘ denotes flooring, the size of each of the former N−1 granularities is N′ RBs, and the size of the last granularity is: number of RBs contained in the whole bandwidth-(N−1)N′.

In the above embodiment, the serving cell to terminal equipment (UE) belongs provides information on the interfering cells, such as an interfering cell list (a neighboring cell list), to the UE via higher layer signaling; wherein the neighboring cell list may comprise the following information: cell ID of the neighboring cells, number of CRS ports of the neighboring cells, and configuration of a multicast broadcast single frequency network (MBSFEN) of the neighboring cells.

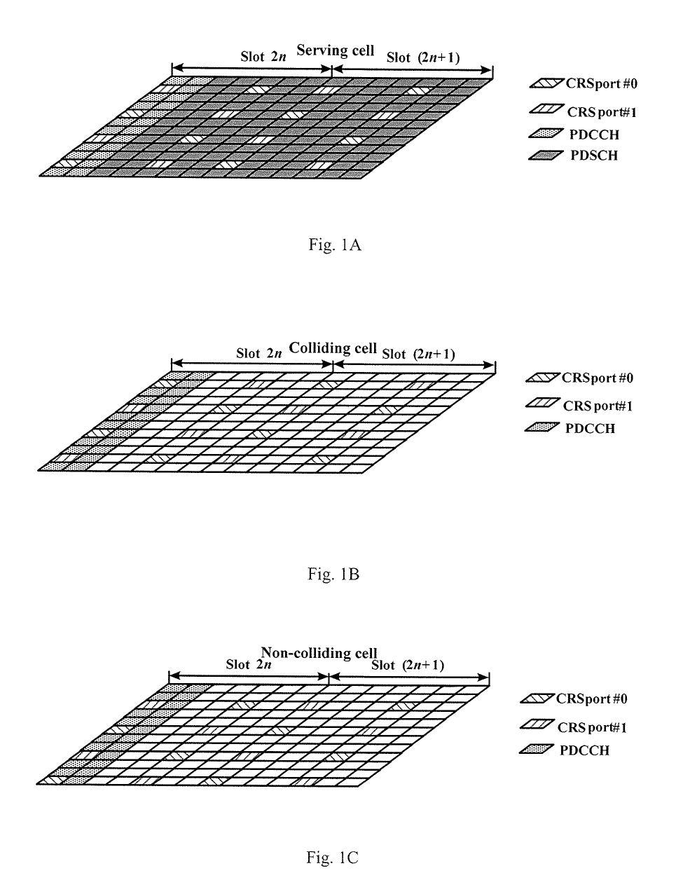

The interfering cells may be divided into two kinds according to the CRS positions of the interfering cells contained in the neighboring cell list: colliding cells and non-colliding cells; wherein the colliding cells refer to that the CRS positions of the interfering cells collide with the CRS positions of the serving cell, and the non-colliding cells refer to that the CRS positions of the interfering cells are offset with the CRS positions of the serving cell. Following description is given taking FIGS. 1A-1C as examples.

FIGS. 1A-1C are schematic diagrams of time-frequency structures of transmission signals of a serving cell, a colliding cell and a non-colliding cell within one resource block (RB) and one subframe, respectively. As shown in FIGS. 1A-1C, all the cells all have two CRS ports, and a PDCCH occupies two orthogonal frequency division multiplexing (OFDM) symbols.

It can be seen from FIGS. 1A-1C that in the ABS scheme, the colliding cells have interference to the CRS signals of the serving cell, while the non-colliding cells only have interference to the control and data signals of the serving cell. Therefore, the colliding cells have an influence on the CRS channel estimation of the serving cell, and further on the detection of the control and data signals, the measurement of RRM and the measurement of CQI. The non-colliding cells only affect the detection of the control and data signals of the serving cell. Therefore, for the colliding cells, CRS interference cancellation needs to be performed in the whole bandwidth; while for the non-colliding cells, for the PDSCH detection, CRS interference cancellation needs to be performed on the configured RBs for PDSCH transmission of the UE, and for the PDCCH detection, CRS interference cancellation needs to be performed in the whole bandwidth.

In the prior art, the bandwidth of the neighboring cells in the neighboring cell list is not given, and the frequency selectivity of the above cell interference is not taken into consideration. Therefore, the UE cannot effectively cancel the CRS interference of the neighboring cells according to the above information. While with the embodiments of the present invention, granularities may be preset as actually required, and for each of the present granularities, CRS interference cancellation may be performed independently based on metric values of the interfering cells and/or a predetermined order. In this way, in performing CRS interference cancellation, the frequency selectivity of the interference is taken into consideration, thereby effectively performing interference cancellation, and increasing the accuracy of UE channel estimation and improving demodulation performance, even if the bandwidths of the cells are different.

The interference cancellation apparatus, the receiver and the interference cancellation method of the embodiments of the present invention shall be described below in detail with reference to the drawings.

Interference cancellation based on metric values of the interfering cells shall be described first.

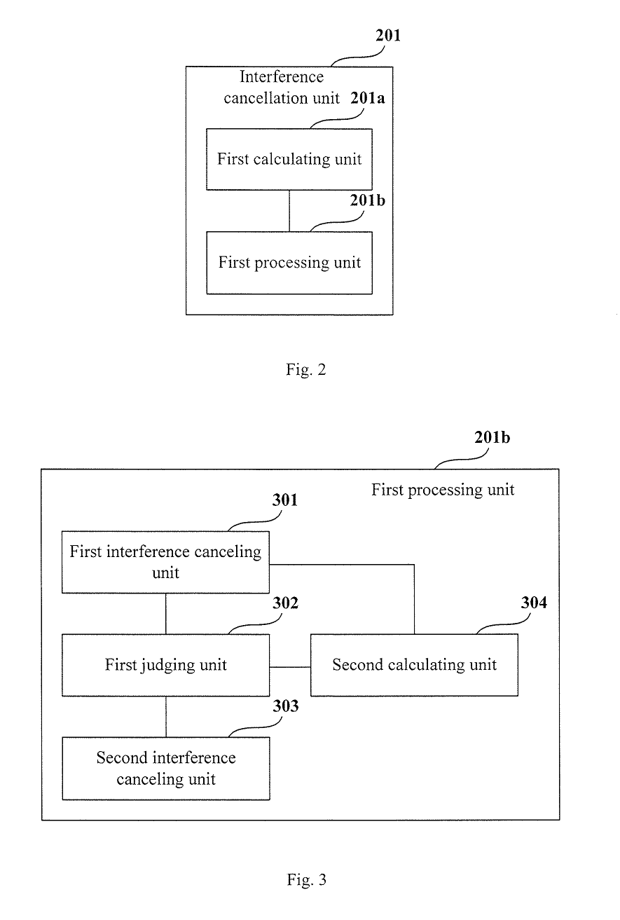

FIG. 2 is a structural diagram of the interference cancellation apparatus of Embodiment 1 of the present invention. As shown in FIG. 2, the apparatus comprises: an interference cancellation unit 201 configured to, based on preset granularities, seriatim perform interference cancellation on interference on common reference signals (CRSs) of interfering cells in each granularity; wherein for each granularity, the interference cancellation is performed based on metric values of the interfering cells;

in this case, the granularities denote a whole bandwidth or a part of the whole bandwidth, the number of corresponding granularities is N, N being an integer greater than or equal to 1, and the interfering cells are neighboring cells having interference on the serving cell to which a receiver belongs.

In the above embodiment, when N=1, it denotes the whole bandwidth; and when N>1, it denotes that the whole bandwidth is divided into N granularities, each granularity being a part of the whole bandwidth.

In this embodiment, CRS interference cancellation may be performed independently for each preset granularity based on the metric values of the interfering cells. In performing the CRS interference cancellation on the interfering cells in each granularity, as shown in FIG. 2, the interference cancellation unit 201 may comprise a first calculating unit 201a and a first processing unit 201b; wherein,

the first calculating unit 201a is configured to calculate metric values of the interfering cells based on receiving signals of CRS resource elements (REs) of the interfering cells in each granularity, and the first processing unit 201b is configured to perform CRS interference cancellation on interference on the CRSs of the interfering cells according to the metric values obtained by the first calculating unit through calculation.

The interfering cell list may comprise one or more interfering cells. Therefore, at the starting stage of the interference cancellation, the first calculating unit 201a calculates metric values of each interfering cell.

The first processing unit 201b may perform interference cancellation on interference on the CRSs of the interfering cells in the list according to the metric values obtained by the first calculating unit 201a through calculation, wherein interference cancellation may be performed on interference on the CRSs of all or part of the interfering cells in the neighboring cell list.

In this embodiment, the first calculating unit 201b may perform interference cancellation on interference on the CRSs of the interfering cells in a descending order of the metric values. That is, interference cancellation is performed first on the interfering cell of the maximum metric value (best signal quality), and then interference cancellation is performed on the interfering cell to which the maximum metric value corresponds in other interfering cells having not been performed interference cancellation when there exists no colliding CRS position in the other interfering cells having not been performed interference cancellation and the interfering cell having been performed interference cancellation, and so on, which shall not be described herein any further. In addition, when there exists a colliding CRS position in the other interfering cells having not been performed interference cancellation and the interfering cell having been performed interference cancellation, the metric values of the other interfering cells having not been performed interference cancellation and having CRS positions colliding with those of the interfering cell having been performed interference cancellation need to be recalculated, and then CRS interference cancellation is performed on the interfering cells in an order of magnitudes of the calculated metric values and the metric values of the other interfering cells having not been performed interference cancellation and having no CRS positions colliding with those of the interfering cell having been performed interference cancellation.

FIG. 3 is a schematically structural diagram of the first processing unit in Embodiment 1 of the present invention. In this embodiment, as shown in FIG. 3, the first processing unit 201b may comprise a first interference canceling unit 301, a first judging unit 302 and a second interference canceling unit 303; wherein the first interference canceling unit 310 is configured to perform interference cancellation on interference on CRSs of the interfering cell to which the current maximum metric value corresponds; the first judging unit 302 is configured to judge whether the CRS positions in the interfering cells without being performed interference cancellation collide with those of the interfering cell to which the current maximum metric value corresponds having been performed interference cancellation on interference on the CRSs, and the second interference canceling unit 303 is configured to, when the judgment result of the first judging unit 302 is that there is no colliding CRS position, perform interference cancellation on interference on the CRSs of the interfering cells without being performed interference cancellation to which maximum metric values except the current maximum metric value correspond.

In this embodiment, as shown in FIG. 3, the first processing unit 201b further comprises a second calculating unit 304 configured to, when the judgment result of the first judging unit 302 is that there are colliding CRS positions, recalculate metric values of the interfering cells without being performed interference cancellation having CRS positions colliding with those of the interfering cells to which the current maximum metric value correspond having been performed interference cancellation on interference on the CRSs;

and after the second calculating unit 304 calculates metric values of the interfering cells without being performed interference cancellation having colliding CRS positions, turning back to the first interference canceling unit 301, and the first interference canceling unit 301 performs interference cancellation on interference on the CRSs of the interfering cell to which the maximum metric value in the metric values of the interfering cells having not been performed interference cancellation and having no CRS position colliding with those of the interfering cells to which the current maximum metric value correspond having been performed interference cancellation and the metric values obtained by the second calculating unit 304 through calculation corresponds. And then the first judging unit 302 and the second interference canceling unit 303 are performed in turn, and so on, which shall not be described herein any further.

In this embodiment, as inter-cell interference having frequency selectivity is taken into consideration, in some scenarios, in different granularities, the levels of interference are significantly different. For example, for multiple neighboring cells (interfering cells), the metric values are relatively small at a certain granularity. In such a case, if the CRS channel estimation of the interfering cells are accurate, little performance gain will be brought about by performing CRS interference cancellation on these neighboring cells; or if the CRS channel estimation of the interfering cells are inaccurate, performing CRS interference cancellation on these cells will even result in loss of performance. Therefore, in order to avoid the above problem, interfering cells on which interference cancellation is to be performed may be determined according to the metric value of each interfering cell. For example, CRS interference cancellation may be performed on an interfering cell of a metric value greater than a first threshold value, while no CRS interference cancellation is performed on interfering cells of metric values less than the first threshold value.

In such a case, for each granularity, the first processing unit 201b is further configured to take the interfering cells to which the metric values greater than the first threshold value correspond as the interfering cells on which CRS interference cancellation is to be performed. In this way, before the first interference canceling unit 301 and the second interference canceling unit 303 perform CRS interference cancellation on the interfering cells to which the current maximum metric value corresponds, whether the current maximum metric value is greater than or equal to the first threshold value is judged first, and interference cancellation is performed if yes; otherwise, interference cancellation is performed on the interfering cells of the next granularity.

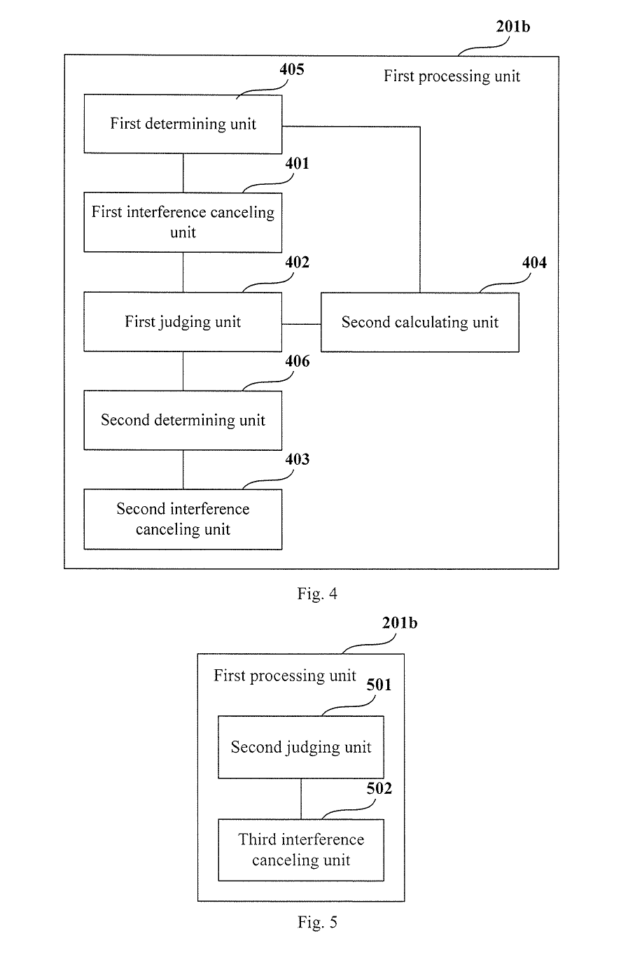

FIG. 4 is a schematically structural diagram of the first processing unit in Embodiment 1 of the present invention. As shown in FIG. 4, the first processing unit 201b comprises a first interference canceling unit 401, a first judging unit 402 and a second interference canceling unit 403, with the functions of them being similar to those of the first processing unit 201b shown in FIG. 3, which shall not be described herein any further.

Furthermore, as shown in FIG. 4, the first processing unit 201b may comprise a first determining unit 405 and a second determining unit 406, which are respectively configured to judge whether the current maximum metric value is greater than or equal to the first threshold value before the first interference canceling unit 401 and the second interference canceling unit 403 perform CRS interference cancellation on the interfering cells to which the current maximum metric value corresponds, and perform CRS interference cancellation on the interfering cells to which the current maximum metric value corresponds if yes; otherwise, perform interference cancellation on the interfering cells of the next granularity.

And if the result of judgment of the first judging unit 402 is that there are colliding CRS positions, the second calculating unit 404 recalculates the metric values of the interfering cells having not been performed interference cancellation and having CRS positions colliding with those of the interfering cells having been cancelled CRS interference, then turning back to the first determining unit 405 for judging whether the current maximum metric value is greater than or equal to the first threshold value, and processing is performed in turn, which shall not be described herein any further.

In this embodiment, in performing interference cancellation by the first interference canceling units 301 and 401 and the second interference canceling units 303 and 403, the CRS interference cancellation may be performed by means of any existing technology, which shall not be described herein any further.

Furthermore, in this embodiment, the CRS interference cancellation may be performed according to the calculated metric values. As channel estimation needs to be performed in interference cancellation, different channel estimation methods are selected for the cases where the metric values are greater than, equal to and less than a second threshold value.

FIG. 5 is a schematically structural diagram of the first processing unit in Embodiment 1 of the present invention. As shown in FIG. 5, the first processing unit 201b comprises a second judging unit 501 and a third interference canceling unit 502; wherein the second judging unit 501 is configured to judge that a calculated metric value is greater than or equal to a second threshold value or less than the second threshold value, and the third interference canceling unit 502 is configured to, when interference cancellation is performed on interference on CRSs of the interfering cells, use different channel estimation methods to respectively estimate interfering cell CRS channels for the cases where a metric value is greater than or equal to a second threshold value and less than the second threshold value.

Furthermore, the first processing unit 201b shown in FIGS. 3 and 4 may comprise a judging unit (not shown) configured to judge that a calculated metric value is greater than or equal to the second threshold value or less than the second threshold value. In this way, before the first interference canceling units 301 and 401 and the second interference canceling units 303 and 403 perform interference cancellation, the judging unit judges that the metric value is greater than or equal to the second threshold value or less than the second threshold value, and then the first interference canceling units 301 and 401 and the second interference canceling units 303 and 403 use different channel estimation methods for channel estimation according to the cases of the metric values.

In this embodiment, the second threshold value may be determined as actually required. For example, the determination of the magnitude of the second threshold value is dependent upon a selected channel estimation algorithm. Particularly, there exist points of intersection between the metric values of two channel estimation algorithms selected for adaptive handover and the performance curves of mean square error (MSE), that is, there exist different channel estimation algorithms having minimum MSE performance in different metric value intervals.

For example, if the channel estimation algorithm based on time domain filtering of fast Fourier transform (FFT) and the MMSE channel estimation algorithm based on Wiener filtering are selected for use, the second threshold value may be set as −1 dB (metric value logarithmized); the channel estimation algorithm based on time domain filtering of FFT is adopted if the metric value is greater than or equal to −1 dB, and the MMSE channel estimation algorithm based on Wiener filtering is adopted if the metric value is less than −1 dB.

In this embodiment, for each granularity, the first processing unit 201b calculates a metric value of each interfering cell, the metric value being any value indicating interfering CRS signal quality. For example, the metric value may be a signal to interference plus noise ratio (SINR) of a corresponding interfering cell, or useful signal power of a corresponding interfering cell, etc. And the first processing unit 201b may be calculated the metric value by using any existing method.

In this embodiment, a method for calculating metric values is also provided. Following description is given to a method of calculating metric values of interfering cells in a granularity of N granularities by the first processing unit 201b taking that the metric values are SINRs as an example.

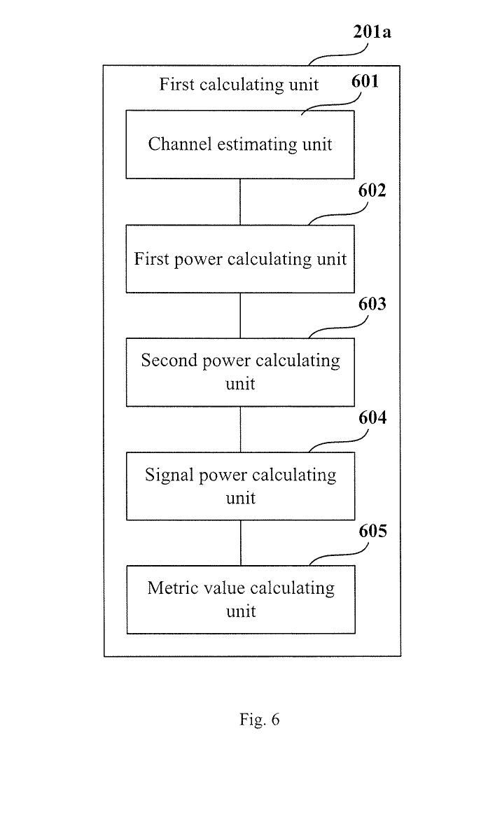

FIG. 6 is a schematically structural diagram of the first calculating unit in Embodiment 1 of the present invention. As shown in FIG. 6, the first calculating unit 201a comprises a channel estimating unit 601, a first power calculating unit 602, a second power calculating unit 603, a signal power calculating unit 604 and a metric value calculating unit 605. Following is detailed description of these components.

The channel estimating unit 601 is configured to calculate least square (LS) channel estimation at the CRS REs of the interfering cells within the granularity;

in this case, at a j-th receiving antenna and an n-th slot, the LS channel estimation of a p-th CRS port of the interfering cells may be expressed by formula (1) below:

H_{LS}(j,n,m,k)=R(j,n,m,k)·(S_{CRS}(n,m,k))* (1);

in formula (1), pε(0,1), H_{LS} denotes the LS channel estimation, (m,k) denotes an RE at an m-th OFDM and at a k-th subcarrier corresponding to an RE of the p-th CRS ports of the interfering cells, R(j,n,m,k) denotes a receiving signal at RE(m,k) and the j-th receiving antenna and the n-th slot, S_{CRS}(n,m,k) denotes a CRS sequence of the interfering cells at the n-th slot RE(m,k), and * denotes a conjugation.

The first power calculating unit 602 is configured to obtain interference and noise power of the interfering cells according to the LS channel estimation result of the channel estimating unit 601;

in this case, the interference and noise power is obtained from a difference among some adjacent LS channel estimation values within the granularity by assuming that channels are invariant among these adjacent CRS REs; an example is given below:

the interference and noise power of the interfering cells calculated by the REs corresponding to the p-th CRS port of the interfering cells at the j-th receiving antenna and the n-th slot may be expressed by formula (2) below:

$${σ}^{2} ( j , n , p ) = \frac{1}{{N}_{RS} - 1} {\sum }_{i = 0}^{{N}_{RS} - 2} {\vert \begin{matrix}\frac{{H}_{LS} ( j , n , 0 , k ( p , 0 , i ) ) + {H}_{LS} ( j , n , {N}_{sym} - 3 , k ( p , {N}_{sym} - 3 , i + 1 ) )}{2} \\ - \frac{{H}_{LS} ( j , n , 0 , k ( p , 0 , i + 1 ) ) + {H}_{LS} ( j , n , {N}_{sym} - 3 , k ( p , {N}_{sym} - 3 , i ) )}{2}\end{matrix} \vert}^{2} ; \qquad ( 2 )$$

where, σ² denotes the interference and noise power, k(p,m,i) denotes a subcarrier index of an i-th CRS RE corresponding to the p-th CRS port of the interfering cells within the granularity at a m-th OFDM symbol, N_{RS} denotes the number of CRS REs for an OFDM symbol within the granularity, and the maximum number of CRS ports utilized for calculating the metric values is 2, mε{0,N_{sym}−3}, where, N_{sym} is the number of OFDM symbols in a slot.

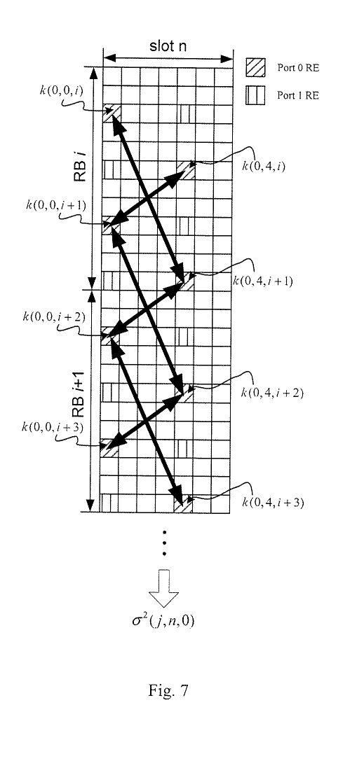

FIG. 7 is a schematic diagram of calculating interference and noise power by a CRS RE of a common CP based on port 0 in LET/LET-A, and what is denoted by it is the calculation of formula (2), a difference among LS estimation values on four adjacent CRS REs within the granularity being used for calculating the interference and noise power.

It can be seen from the above embodiment that the interference and noise power may be calculated by using formula (2), and may also be obtained by using other methods. For example, the interference and noise power may be calculated by using formulae (3), (4) or (5).

$$\begin{matrix}{σ}^{2} ( j , n , p ) = \frac{1}{{N}_{RS} - 1} {\sum }_{i = 0}^{{N}_{RS} - 2} {\vert \begin{matrix}\frac{{H}_{LS} ( j , n - 1 , {N}_{sym} - 3 , k ( p , {N}_{sym} - 3 , i ) ) + {H}_{LS} ( j , n , 0 , k ( p , 0 , i + 1 ) )}{2} \\ - \frac{{H}_{LS} ( j , n - 1 , {N}_{sym} - 3 , k ( p , {N}_{sym} - 3 , i + 1 ) ) + {H}_{LS} ( j , n , 0 , k ( p , 0 , i ) )}{2}\end{matrix} \vert}^{2} , & ( 3 ) \\ {σ}^{2} ( j , n , p ) = \frac{1}{2 ( {N}_{RS} - 1 )} {\sum }_{i = 0}^{{N}_{RS} - 2} {\vert {H}_{LS} ( j , n , 0 , k ( p , 0 , i ) ) - {H}_{LS} ( j , n , 0 , k ( p , 0 , i + 1 ) ) \vert}^{2} , & ( 4 ) \\ {σ}^{2} ( j , n , p ) = \frac{1}{{N}_{RS} - 3} {\sum }_{i = 0}^{{N}_{RS} - 4} {\vert \begin{matrix}\frac{{H}_{LS} ( j , n , 0 , k ( p , 0 , i ) ) + {H}_{LS} ( j , n , 0 , k ( p , 0 , i + 2 ) )}{2} - \\ \frac{{H}_{LS} ( j , n , 0 , k ( p , 0 , i + 1 ) ) + {H}_{LS} ( j , n , 0 , k ( p , 0 , i + 3 ) )}{2}\end{matrix} \vert}^{2} . & ( 5 )\end{matrix}$$

In formulae (3)-(5), pε(0,1), and meanings of other signs identical to those of the signs in formula (2) shall not be described any further.

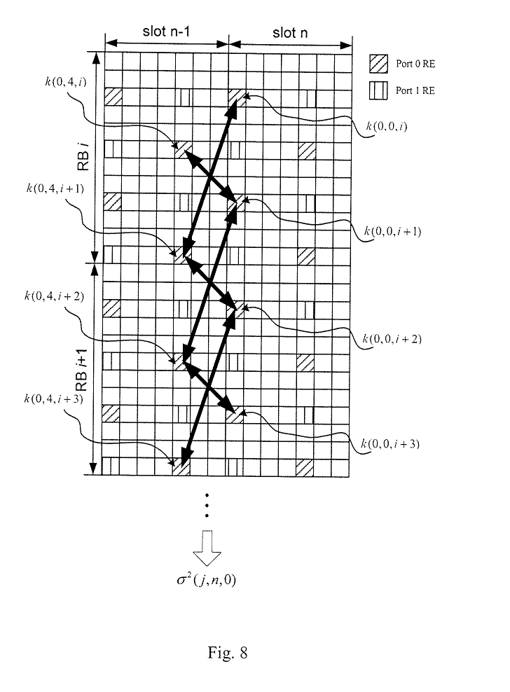

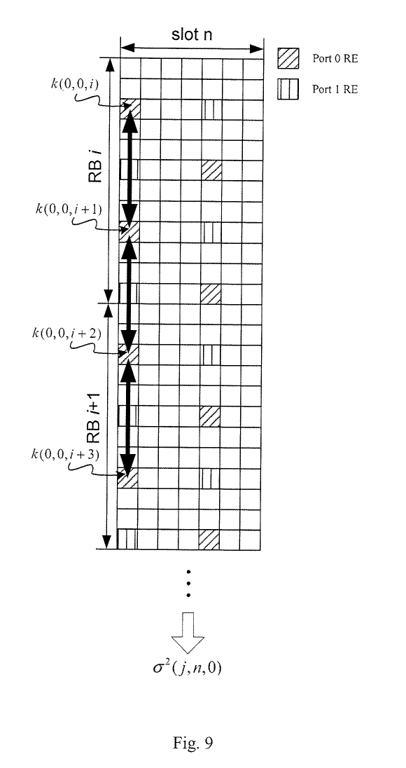

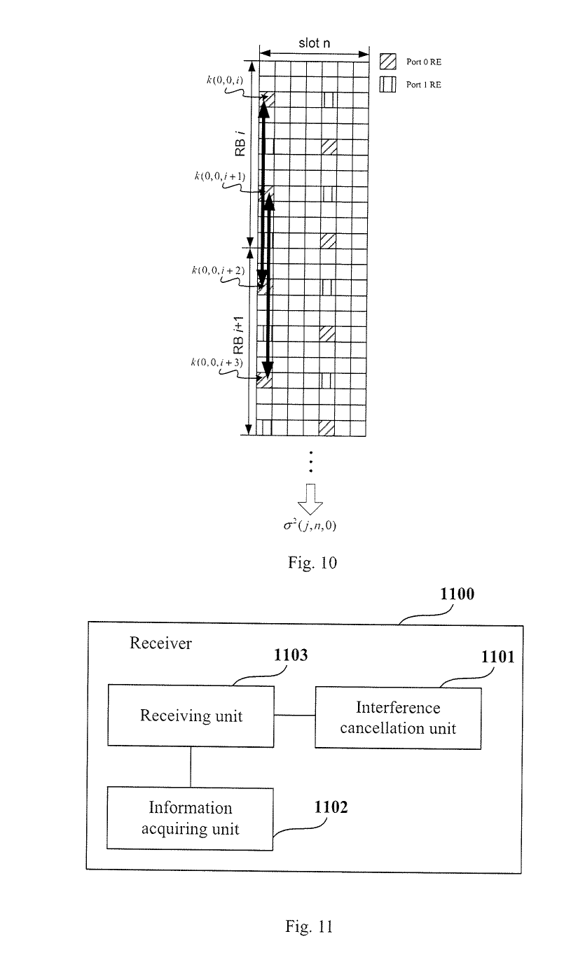

FIGS. 8, 9 and 10 are schematic diagrams of calculating interference and noise power by a CRS RE of a common cyclic prefix (CP) based on port 0 in LTE/LTE-A. Wherein FIG. 8 corresponds to formula (3), FIG. 9 corresponds to formula (4), and FIG. 10 corresponds to formula (5). The method shown in FIG. 8 uses a difference between LS estimation values on adjacent CRS REs of two neighboring slots within the granularity to calculate the interference and noise power, and in FIGS. 9 and 10, a difference between LS estimation values on CRS REs of an OFDM symbol within a granularity to calculate the interference and noise power.

In formulae (2)-(5), the interference and noise power is calculated for one slot. In this way, in the whole time domain, the final interference and noise power calculated by the REs at the j-th receiving antenna and the n-th slot corresponding to the p-th CRS port of the interfering cells may be expressed by formula (6):

$${\tilde{σ}}^{2} ( j , n , p ) = \{ \begin{matrix}{σ}^{2} ( j , n , p ) , & n = 0 \\ α \cdot {σ}^{2} ( j , n , p ) + ( 1 - α ) \cdot {\tilde{σ}}^{2} ( j , n - 1 , p ) , & other\end{matrix} ; \qquad ( 6 )$$

where, α denotes a forgetting factor in the time domain, with a range of values of (0<α≦1).

The second power calculating unit 603 is configured to obtain LS signal power of the interfering cells according to the LS channel estimation result;

in this case, in the granularity, when the interference and noise power among some adjacent LS channel estimation values is reduced by averaging, useful signal power is maintained by assuming that channels are invariant among these adjacent CRS REs; the second power calculating unit 603 may obtain the LS signal power of the interfering cells by using any existing method; and a method is proposed in this embodiment, which is described below by way of an example.

The averaged LS signal power calculated by the REs corresponding to the p-th CRS port of the interfering cells at the j-th receiving antenna may be expressed by formula (7):

$${P}_{LS} ( j , n , p ) = \frac{1}{{N}_{RS} - 1} {\sum }_{i = 0}^{{N}_{RS} - 2} {\vert \begin{matrix}\frac{{H}_{LS} ( j , n , 0 , k ( p , 0 , i ) ) + {H}_{LS} ( j , n , {N}_{sym} - 3 , k ( p , {N}_{sym} - 3 , i + 1 ) )}{4} \\ + \frac{{H}_{LS} ( j , n , 0 , k ( p , 0 , i + 1 ) ) + {H}_{LS} ( j , n , {N}_{sym} - 3 , k ( p , {N}_{sym} - 3 , i ) )}{4}\end{matrix} \vert}^{2} . \qquad ( 7 )$$

In this embodiment, besides using formula (7) to calculate the LS signal power, it may also be calculated by using formulae (8) and (9):

$$\begin{matrix}{P}_{LS} ( j , n , p ) = \frac{1}{{N}_{RS} - 1} {\sum }_{i = 0}^{{N}_{RS} - 2} {\vert \begin{matrix}\frac{{H}_{LS} ( j , n - 1 , {N}_{sym} - 3 , k ( p , {N}_{sym} - 3 , i ) ) + {H}_{LS} ( j , n , 0 , k ( p , 0 , i + 1 ) )}{4} \\ + \frac{{H}_{LS} ( j , n - 1 , {N}_{sym} - 3 , k ( p , {N}_{sym} - 3 , i + 1 ) ) + {H}_{LS} ( j , n , 0 , k ( p , 0 , i ) )}{4}\end{matrix} \vert}^{2} ; & ( 8 ) \\ {P}_{LS} ( j , n , p ) = \frac{1}{{N}_{RS} - 1} {\sum }_{i = 0}^{{N}_{RS} - 2} {\vert \frac{{H}_{LS} ( j , n , 0 , k ( p , 0 , i ) ) + {H}_{LS} ( j , n , 0 , k ( p , 0 , i + 1 ) )}{2} \vert}^{2} . & ( 9 )\end{matrix}$$

In formulae (7)-(9), the LS signal power is calculated for one slot. For the whole time domain, the final LS signal power calculated by the REs corresponding to the p-th CRS port of the interfering cells at the j-th receiving antenna and the n-th slot is:

$${\tilde{P}}_{LS} ( j , n , p ) = \{ \begin{matrix}{P}_{LS} ( j , n , p ) , & n = 0 \\ α \cdot {P}_{LS} ( j , n , p ) + ( 1 - α ) \cdot {\tilde{P}}_{LS} ( j , n - 1 , p ) , & other\end{matrix} . \qquad ( 10 )$$

In formulae (7)-(9), the meanings of the signs are same as those of the signs in formulae (1)-(6), and the values may be identical or different, which shall not be described herein any further.

The signal power calculating unit 604 is configured to calculate signal power by using the interference and noise power calculated by the first power calculating unit 602 and the LS signal power calculated by the second power calculating unit 603;

The signal power calculated by the REs corresponding to the p-th CRS port of the interfering cells at the j-th receiving antenna and the n-th slot may be expressed by formula (11):

$$\tilde{P} ( j , p , n ) = {\tilde{P}}_{LS} ( j , p , n ) - \frac{1}{N} {\tilde{σ}}^{2} ( j , p , n ) ; \qquad ( 11 )$$

where, N is a normalization factor to be matched with the interference and noise power in \tilde{P}_{LS}(j,p,n); where, for the LS signal power calculated by using formulae (7) and (8), N=4, and for the LS signal power calculated by using formula (9), N=2.

The metric value calculating unit 605 is configured to calculate the metric values according to the obtained interference and noise power and signal power of the interfering cells;

Wherein, the metric values are SINRs;

and the metric values SINRs at the n-th slot may be calculated in the following manner: calculating the metric values by averaging a ratio of the interference and noise power \tilde{σ}²(j,n,p) obtained by the first power calculating unit 602 and the signal power \tilde{P}²(j,p,n) obtained by the signal power calculating unit 604 through calculation, which may be expressed by formula (12) as:

$$SINR ( n ) = \frac{1}{{N}_{R}} {\sum }_{j}^{ } \frac{{\sum }_{p}^{ } \tilde{P} ( j , p , n )}{{\sum }_{p}^{ } {\tilde{σ}}^{2} ( j , p , n )} \qquad ( 12 )$$

where, N_{R} denotes the number of the receiving antennas.

Furthermore, formula (12) may be expressed by a more general expression, such as formulae (13) and (14):

$$\begin{matrix}SINR ( n ) = γ \cdot {\sum }_{j}^{ } \frac{{\sum }_{p}^{ } \tilde{P} ( j , p , n )}{{\sum }_{p}^{ } {\tilde{σ}}^{2} ( j , p , n )} , & ( 13 ) \\ SINR ( n ) = γ \cdot {\sum }_{j}^{ } {\sum }_{p}^{ } \frac{\tilde{P} ( j , p , n )}{{\tilde{σ}}^{2} ( j , p , n )} ; & ( 14 )\end{matrix}$$

where, γ is a normalization factor.

In the above embodiment, how to calculate the metric values SINRs by the first calculating unit 201a is described in detail. Furthermore, the first interference canceling units 301 and 401 and the second interference canceling units 303 and 403 in the first calculating unit 201a may use any existing method to cancel CRS interference, which is described below by way of an example.

In performing interference cancellation, channel estimation is performed first on the interfering CRS signals, and then CRS interference cancellation is performed according to the result of channel estimation after the channel estimation is performed, which is described below in detail.

First, channel estimation is performed first on the interfering CRS signals;

in this case, the CRS channel estimation of the interfering cells corresponding to the j-th receiving antenna and the p-th CRS port may be expressed by formula (15):

\tilde{H}_{j,p}=Wₚ·H_{j,p} (15);

where, H_{j,p} is a vector consists of LS channel estimation values {H_{LS}(j,n,m,k)}, corresponding to the j-th receiving antenna and the p-th CRS port of the interfering cells within the granularity;

and Wₚ is a filtering matrix, corresponding to the p-th CRS port of the interfering cells, and may be obtained by using different algorithms, such as Wiener filtering and linear average algorithms, etc.

For example, the N_{LS}×N_{LS} filtering matrix Wₚ is obtained by formula (16) according to a linear average:

$${W}_{p} = [ \begin{matrix}w & w & … & w \\ w & w & ⋮ & w \\ ⋮ & ⋮ & ⋮ & ⋮ \\ w & w & … & w\end{matrix} ] ; \qquad ( 16 )$$

where,

$$w = \frac{1}{{N}_{LS}} ; \qquad ( 17 )$$

N_{LS} is the length of the vector H_{j,p}.

For example, formula (18) is the filtering matrix Wₚ obtained based on the Wiener method by using the SINRs calculated by formula (12):

$${W}_{p} = {{R}_{{H}_{p} {H}_{p}} ( {R}_{{H}_{p} {H}_{p}} + \frac{1}{SINR} I )}^{- 1} ; \qquad ( 18 )$$

where, R_{H}_{ₚ}_{H}_{ₚ} denotes a correlation matrix of the vector H_{j,p}, and is dependent on time-frequency relative positions of different elements of the vector.

Furthermore, when the granularity is the whole bandwidth, a channel estimation algorithm based on the time domain filtering of FFT transform may also be employed.

Second, after the channel estimation, CRS interference cancellation is performed;

in this case, at the j-th receiving antenna, the receiving signal after interference cancellation may be expressed by formula (19) as:

Y(j,n,m,k)=Y(j,n,m,k)−\tilde{H}(j,n,m,k)·S_{CRS}(n,m,k) (19);

where, Y(j,n,m,k) denotes received signals, and \tilde{H}(j,n,m,k) denotes the channel estimation.

How to calculate metric values and how to perform CRS interference cancellation are described above by way of examples. However, the above methods of calculating metric values and performing CRS interference cancellation may also be realized by other existing methods, which shall not be described herein any further.

In this embodiment, measurement corresponding to the serving cell and detection of signaling and data may be realized by canceling CRS interference by the interference cancellation apparatus. As CRS interference is cancelled, accuracy of channel estimation may be increased and performance of demodulation may be improved.

FIG. 11 is a structural diagram of the receiver of Embodiment 2 of the present invention. As shown in FIG. 11, the receiver 1100 may comprise an interference cancellation unit 1101 configured to, based on preset granularities, seriatim perform interference cancellation on interference on common reference signals (CRSs) of interfering cells in each granularity; wherein in performing interference cancellation on the interference on the CRSs of the interfering cells in each granularity, the interference cancellation is performed based on metric values of the interfering cells and/or a predetermined order of interference cancellation; and the interference cancellation unit 1101 may be realized by any one of the interference cancellation apparatuses of Embodiment 1, which shall not be described herein any further.

As shown in FIG. 11, the receiver 1100 may further comprise an information acquiring unit 1102 configured to receive interfering cell information notified by the serving cell to which the receiver belongs; wherein the interfering cell information may be notified to the UE in a manner of a list, and is as described in Embodiment 1, which shall not be described herein any further.

Furthermore, the receiver 1100 may comprise a signal receiving unit 1103 configured to receive signals transmitted by the network side, and transmit the signals to the interference cancellation unit 1101.

Furthermore, the receiver 1100 may comprise a storing unit (not shown) configured to store the interfering cell information.

For example, the receiver 1100 may be a mobile phone, a PDA, and a notebook computer, etc.

In this embodiment, all the parts in embodiments 1 and 2 may be realized by specific hardware, firmware, software, or a combination thereof, without departing from the scope of the present invention.

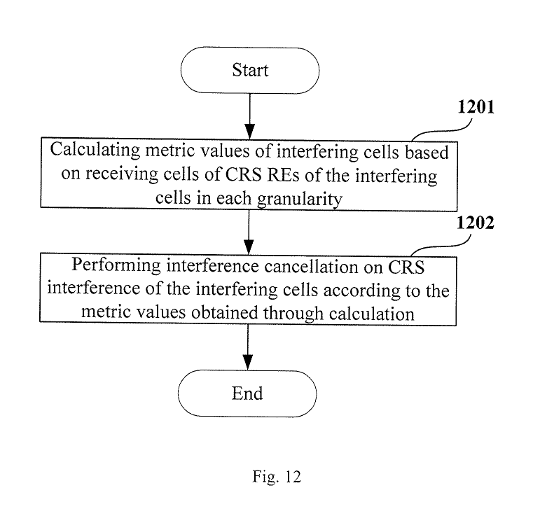

FIG. 12 is a flowchart of the interference cancellation method of Embodiment 3 of the present invention.

The interference cancellation method of the embodiment of the present invention shall be described below taking that N granularities are preset and the number of the interfering cells in the interfering cell list is M as an example.

As shown in FIG. 12, for each of the N granularities, the method comprises:

step 1201: calculating metric values of interfering cells based on receiving cells of CRS REs of the interfering cells in each granularity;

in this embodiment, the metric values may be calculated by using any existing method; furthermore, if the metric values are SINRs, the calculation method provided in Embodiment 1 of the present invention may be used, and the calculation is performed by the first calculating unit 201a, which shall not be described herein any further; and the interfering cells may be one or more;

step 1202: performing interference cancellation on CRS interference of the interfering cells according to the metric values obtained through calculation;

in this embodiment, for each granularity, interference cancellation on CRS interference of the interfering cells may be performed according to the metric values obtained through calculation; wherein the interference cancellation method is as described in Embodiment 1, and may be realized by the first calculating unit 201a, the contents of which being incorporated herein, and shall not be described herein any further; and if the CRS interference of all the interfering cells of the current granularity is cancelled, CRS interference in the next granularity is cancelled, and so on, until CRS interference of all the interfering cells of all the granularities is cancelled.

It can be seen from the above embodiment that the UE may independently perform CRS interference cancellation based on the metric values of the interfering cells for each preset granularity according to the preset granularities. In this way, in performing CRS interference cancellation, frequency selectivity of interference is taken into consideration, thereby increasing the accuracy of UE channel estimation and improving demodulation performance.

In this embodiment, interference cancellation may be performed in step 1202 by using the method as shown in FIGS. 3 and 4 of Embodiment 1, the contents of which being incorporated herein, and shall not be described herein any further.

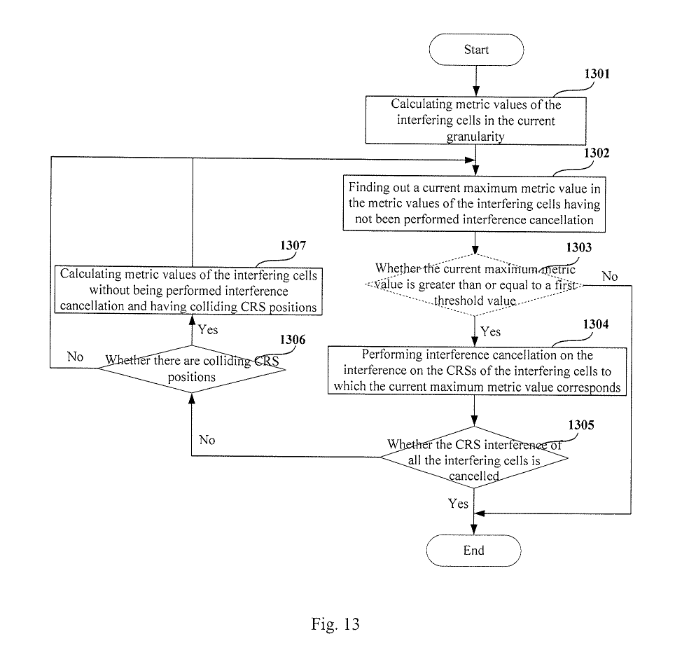

FIG. 13 is a flowchart of performing interference cancellation on the CRSs of an interfering cell in a granularity in Embodiment 4 of the present invention, which shall be described taking a current granularity of N granularities, such an i-th granularity, and that M interfering cells are contained in the granularity, as an example. At the beginning, no interference cancellation is performed for all the interfering cells. And M and N are integers greater than or equal to 1.

As shown in FIG. 13, the method comprises:

step 1301: calculating metric values of the interfering cells in the current granularity;

wherein, in the initial calculation, the number of the interfering cells contained in the granularity having not been performed interference cancellation is M, and the metric values may be SINRs, with the calculation method being similar to the method of calculating metric values by the first calculating unit 201a of Embodiment 1, the contents of which being incorporated herein, and shall not be described herein any further; in this way, M metric values may be calculated;

in the above embodiment, the SINRs obtained through calculation are directly taken as the metric values; however, it is not limited thereto, and the values obtained by logarithmizing the SINRs may be taken as the metric values, that is, the metric values are 10*lg(SINR), which may be determined as actually required;

step 1302: finding out a current maximum metric value in the metric values of the interfering cells having not been performed interference cancellation;

in this embodiment, at the beginning, the current maximum metric value is found out from M metric values; but after canceling CRS interference of K interfering cells in M interfering cells, a maximum value is found out from the metric values of the left M-K interfering cells with CRS interference being not cancelled;

in this embodiment, the current maximum metric value is expressed as Cmax;

step 1303: judging the current maximum metric value is greater than or equal to a first threshold value, and executing step 1304 if yes; otherwise, terminating this process;

in this embodiment, the first threshold value TH1 may be determined as actually required; for example, when the values obtained by logarithmizing the SINRs are taken as the metric values, the first threshold value may be set as −10 dB; this is an embodiment of the present invention only, and it may be set as other values as actually required, which shall not be described herein any further;

step 1304: performing interference cancellation on the interference on the CRSs of the interfering cells to which the current maximum metric value corresponds if the result of judgment in step 1303 is yes;

in this embodiment, in performing interference cancellation, channel estimation is performed first to the interfering CRS signals, and then CRS interference cancellation is performed according the result of channel estimation after the channel estimation is performed; the detailed method is as described in the embodiment, which shall not be described herein any further;

step 1305: judging whether cancellation is performed on the interference of the CRSs of all the interfering cells in the current granularity after step 1304, and terminating the process if the result of judgment is yes; otherwise, executing step 1306;

step 1306: in step 1305, if the result of judgment is no, further judging whether the CRS positions in the interfering cells without being performed interference cancellation collide with those of the interfering cells to which the current maximum metric value Cmax corresponds having been performed interference cancellation on interference on the CRSs, and executing step 1307 if the result of judgment is yes; otherwise, turning back to step 1302;

for example, after cancellation is performed on the interference of the CRSs of the interfering cells to which the current maximum metric value Cₘₐₓ corresponds in step 1304, if there still exist M-K interfering cells, whether the CRS positions in the M-K interfering cells without being performed interference cancellation collide with those of the interfering cells having been performed interference cancellation on interference on the CRSs in step 1304 is further judged; if there is no colliding CRS position, turning back to step 1302 to further judge whether the maximum metric value in the current M-K interfering cells without being performed interference cancellation is greater than or equal to a first predefined value; where, K=1˜M;

step 1307: in step 1306, if the result of judgment is yes, recalculating metric values of the interfering cells without being performed interference cancellation and having CRS positions colliding with those of the interfering cells to which the current maximum metric value Cmax corresponds having been performed interference cancellation;

and after recalculating the metric values of the interfering cells without being performed interference cancellation and having colliding CRS positions, turning back to step 1302 to find out a current maximum metric value from the metric values of the interfering cells without being performed interference cancellation and having colliding CRS positions and the metric values of the interfering cells without being performed interference cancellation and having no colliding CRS position;

then executing subsequent steps in turn, until all the interference on the CRSs of M interfering cells in the i-th granularity is cancelled;

in step 1302, the process is terminated if the result of judgment is no, and it shows that no CRS interference cancellation is needed in the current granularity, and processing should be performed on the next granularity, the method of processing being similar to that shown in FIG. 13, which shall not be described herein any further.

And so on, interference cancellation may be performed on the interference on the CRSs of M interfering cells in each of N granularities.

It can be seen from the above embodiment that the UE may independently perform CRS interference cancellation based on the metric values of the interfering cells for each preset granularity according to the preset granularities, perform interference cancellation in a descending order of the metric values, and perform interference cancellation on the interfering cells of metric values greater than the first threshold value, thereby effectively performing interference cancellation, and increasing the accuracy of UE channel estimation and improving demodulation performance, even if the bandwidths of the cells are different.

It can be seen from the contents of Embodiment 1 that step 1303 is optional, with an object being to solve a problem that there is little performance gain or loss of performance is resulted in performing CRS interference cancellation in some cases.

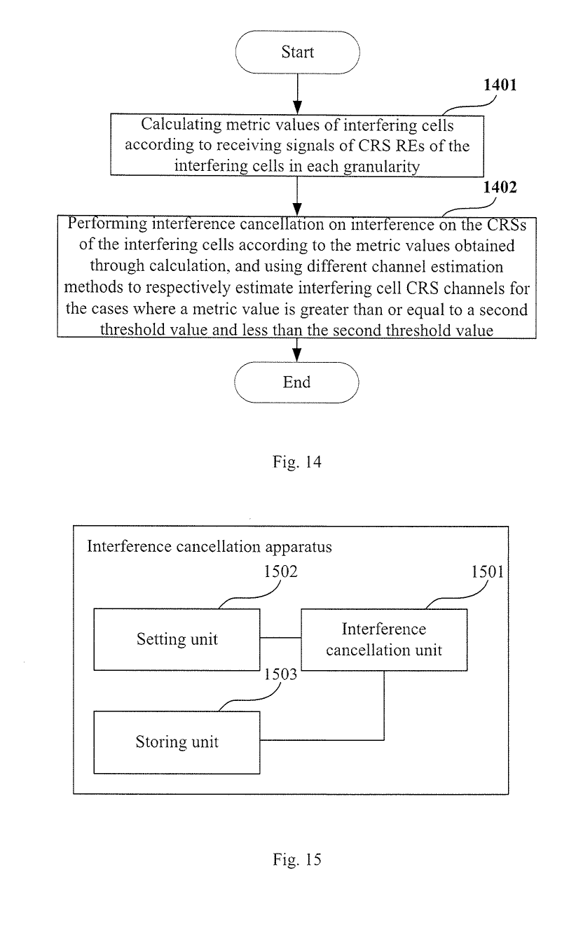

FIG. 14 is a flowchart of the interference cancellation method of Embodiment 5 of the present invention. As shown in FIG. 14, the method comprises:

step 1401: calculating metric values of interfering cells according to receiving signals at CRS REs of the interfering cells within each granularity;

in this embodiment, the metric values may be calculated by using any existing method; furthermore, if the metric values are SINRs, the calculation method provided in Embodiment 1 of the present invention may be used, and the calculation is performed by the first calculating unit 201a, which shall not be described herein any further; the interfering cells may be one or more; and the metric values may be logarithmized SINRs, which shall not be described herein any further;

step 1402: performing interference cancellation on interference on the CRSs of the interfering cells according to the metric values obtained through calculation;

wherein, in performing interference cancellation on the interference on the CRSs of the interfering cells, channel estimation is performed first on the interfering CRS signals, and then CRS interference cancellation is performed according to the channel estimation result after the channel estimation is performed; and wherein different channel estimation methods are used respectively for performing CRS channel estimation of the interfering cells in the cases that the metric values are greater than or equal to the second threshold value and less than the second threshold value. For example, when the metric values are greater than or equal to the second threshold value, a channel estimation algorithm based on the time domain filtering of FFT is used, and when the metric values are less than the second threshold value, a Wiener filtering channel estimation algorithm is used.

In the above embodiment, interference cancellation based on metric values of interfering cells is described. Wherein, the calculation of the metric values of the interfering cells, CRS interference cancellation and corresponding CRS channel estimation may be OFDM symbol-based, slot-based or subframe-based in the time domain. For example, the used area is N physical resource blocks (RBs) in the frequency domain, and is one slot in the time domain; this means that the granularity consists of N physical RBs.

In order to further reduce the amount of calculation, the interference cancellation may be performed without using the method as described above, and CRS interference cancellation is performed based on a predefined interference cancellation order, which shall be described below with reference to the drawings.

FIG. 15 is a structural diagram of the interference cancellation apparatus of Embodiment 6 of the present invention. As shown in FIG. 15, the apparatus comprises: an interference cancellation unit 1501 configured to, based on preset granularities, seriatim perform interference cancellation on interference on common reference signals (CRSs) of interfering cells in each granularity; wherein in performing interference cancellation on the interference on the CRSs of the interfering cells in each granularity, the interference cancellation is performed based on a predetermined order of interference cancellation; and wherein the granularities denote a whole bandwidth or a part of the whole bandwidth, the number of corresponding granularities is N, N being an integer greater than or equal to 1, and the interfering cells are neighboring cells having interference on the serving cell to which a receiver belongs.

In this embodiment, the predetermined order of interference cancellation may be set as actually required.

Furthermore, the predetermined order of interference cancellation may be varied cyclically; however, the order is not varied in a predefined time cycle (which may be a slot or a multiple of subframes), thereby greatly reducing the amount of calculation.

In this embodiment, the method for performing CRS interference cancellation for each interfering cell is similar to that in Embodiment 1, which shall not be described herein any further.

As shown in FIG. 15, the apparatus may further comprise a setting unit 1502 configured to set the order of interference cancellation. If the order of interference cancellation is varied cyclically, the setting unit 1502 cyclically sets the order of interference cancellation.

In this embodiment, after the setting unit 1502 sets the order of interference cancellation, the order of interference cancellation may be stored. Therefore, the apparatus may further comprise a storing unit 1503 configured to store the order of interference cancellation. In this way, the interference cancellation unit 1501 may perform interference cancellation according to the order of interference cancellation set by the setting unit 1502 or stored by the storing unit 1503.

In this embodiment, the order of interference cancellation may be set as actually required, which shall not be described herein any further.

Furthermore, the order of interference cancellation may be set according to the metric values of the interfering cells. For example, in Embodiment 4, the current maximum metric value is found in step 1302, and the current maximum metric value and corresponding cell ID are recorded when the result of judgment in step 1303 is yes or after interference cancellation is performed on the interference on the CRSs of the interfering cells to which the current maximum metric value corresponds in step 1304, and so on; and the current maximum metric value and corresponding cell ID are recorded in turn, until CRS interference of all the interfering cells is cancelled.

Therefore, the storing unit 1503 sequentially records the metric values and corresponding cell ID. Therefore, in performing interference cancellation, the interference cancellation unit 1501 may perform interference cancellation in turn according to the recorded order.

Embodiment 7 of the present invention further provides an interference cancellation apparatus.

The difference between the interference cancellation apparatus and the interference cancellation apparatus of Embodiment 5 exists in that in performing interference cancellation by the interference cancellation unit 1501 on the CRS interference of the interfering cells in each granularity, the interference cancellation is performed based on the metric values of the interfering cells and the predefined order of interference cancellation.

Wherein, the setting unit 1502 may set the order of interference cancellation according to the metric values of the interfering cells, and the storing unit 1503 may store the order and corresponding metric values, the detailed process being as described in Embodiment 5, which shall not be described herein any further.

Furthermore, in performing interference cancellation by the interference cancellation unit 1501, channel estimation is performed first on the interfering CRS signals, and then CRS interference cancellation is performed according to the channel estimation result after the channel estimation is performed; and wherein different channel estimation methods are used respectively for performing CRS channel estimation of the interfering cells in the cases that the metric values are greater than or equal to the second threshold value and less than the second threshold value, which are as described in the above embodiments, and shall not be described herein any further.

In embodiments 5 and 6, the setting unit 1502 may preset an order of interference cancellation according to the metric values, and save the metric values of the interfering cells and the order of interference cancellation; and perform CRS interference cancellation of the interfering cells in a predefined cycle according to the predefined metric values and order of interference cancellation, without recalculating metric values, thereby lowering the complexity of calculation.

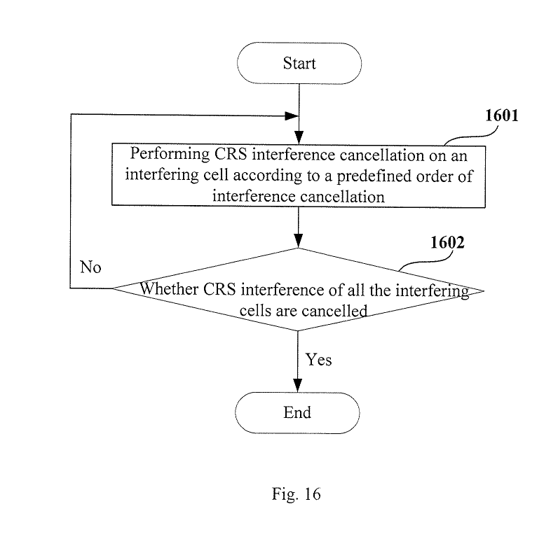

FIG. 16 is a flowchart of the interference cancellation method of Embodiment 8 of the present invention. As shown in FIG. 16, the method comprises:

step 1601: performing CRS interference cancellation on an interfering cell according to a predefined order of interference cancellation; and

step 1602: judging whether CRS interference of all the interfering cells are cancelled, terminating the process if the judgment result is yes, and turning back to step 1601 if the judgment result is no, to perform CRS interference cancellation on an interfering cell following the next interfering cell.

In the above embodiment, a step may be included before step 1601: setting the order of interference cancellation. Wherein any method may be used for setting, and the order of interference cancellation may also be set by using the methods as described in embodiments 3 and 4, and may be set cyclically; and the set order of interference cancellation and/or the metric values may be stored.

In performing interference cancellation in step 1602, different channel estimation methods may be used for performing channel estimation according to whether the metric values are greater than or equal to the second threshold value and less than the second threshold value.

For the implementation of the present invention containing the above embodiments, following supplements are further disclosed.

Supplement 1. An interference cancellation apparatus, comprising:

an interference cancellation unit configured to, based on preset granularities, seriatim perform interference cancellation on interference on common reference signals (CRSs) of interfering cells in each granularity; wherein in performing interference cancellation on the interference on the CRSs of the interfering cells in each granularity, the interference cancellation is performed based on metric values of the interfering cells and/or a predetermined order of interference cancellation; and wherein the granularities denote a whole bandwidth or a part of the whole bandwidth, the number of corresponding granularities is N, N being an integer greater than or equal to 1, and the interfering cells are neighboring cells having interference on the serving cell to which a receiver belongs.

Supplement 2. The apparatus according to supplement 1, wherein for each granularity, in performing the interference cancellation based on metric values of the interfering cells, the interference cancellation unit comprises:

a first calculating unit configured to calculate metric values of the interfering cells according to receiving signals at CRS resource elements of the interfering cells; and

a first processing unit configured to perform interference cancellation on interference on the CRSs of the interfering cells according to the metric values obtained by the first calculating unit through calculation.

Supplement 3. The apparatus according to supplement 2, wherein for each granularity, the first calculating unit is further configured to perform interference cancellation on interference on the CRSs of the interfering cells in a descending order of the metric values.

Supplement 4. The apparatus according to supplement 2 or 3, wherein the first calculating unit is further configured to take the interfering cells to which metric values greater than a first threshold value correspond as the interfering cells on the CRSs of which interference cancellation is performed.

Supplement 5. The apparatus according to supplement 2 or 3 or 4, wherein the first processing unit comprises:

a first interference canceling unit configured to perform interference cancellation on interference on CRSs of the interfering cell to which the current maximum metric value corresponds;

a first judging unit configured to judge whether the CRS positions in the interfering cells without being performed interference cancellation collide with those of the interfering cell to which the current maximum metric value corresponds having been performed interference cancellation on interference on the CRSs; and

a second interference canceling unit configured to, when the judgment result of the first judging unit is that there is no colliding CRS position, perform interference cancellation on interference on the CRSs of the interfering cells without being performed interference cancellation to which maximum metric value except the current maximum metric value correspond.

Supplement 6. The apparatus according to supplement 5, wherein the first processing unit further comprises:

a second calculating unit configured to, when the judgment result of the first judging unit is that there are colliding CRS positions, recalculate metric values of the interfering cells without being performed interference cancellation having CRS positions colliding with those of the interfering cells having been performed interference cancellation on interference on the CRSs;

and the first interference canceling unit is further configured to perform interference cancellation to the CRS interference of the interfering cell to which the maximum metric value in the metric values of the interfering cells having no colliding CRS position and without being performed interference cancellation and the metric values obtained by the second calculating unit through calculation corresponds.

Supplement 7. The apparatus according to supplement 2, wherein the first processing unit comprises:

a second judging unit configured to judge that a calculated metric value is greater than or equal to a second threshold value or less than the second threshold value; and

a third interference canceling unit configured to, when interference cancellation is performed on interference on CRSs of the interfering cells, use different channel estimation methods to respectively estimate interfering cell CRS channels for the cases where a metric value is greater than or equal to a second threshold value and less than the second threshold value.

Supplement 8. The apparatus according to supplement 2, wherein for each granularity, the metric value is a signal to interference plus noise ratio (SINR) of the interfering cells, and the first calculating unit comprises:

a channel estimating unit configured to calculate least square (LS) channel estimation of the interfering cells at the CRS resource element of the interfering cells within each granularity;

a first power calculating unit configured to obtain interference and noise power of the interfering cells according to the LS channel estimation result;

a second power calculating unit configured to obtain LS signal power of the interfering cells according to the LS channel estimation result;

a signal power calculating unit configured to calculate signal power by using the interference and noise power calculated by the first power calculating unit and the LS signal power calculated by the second power calculating unit; and

a metric value calculating unit configured to calculate the metric values according to the obtained interference and noise power and signal power of the interfering cells.

Supplement 9. The apparatus according to supplement 1, wherein for each granularity, when the interference cancellation is performed based on metric values of the interfering cells and/or a predetermined order of interference cancellation, the apparatus further comprises:

a setting unit configured to determine an order of interference cancellation according to the metric values of the interfering cells;

and in performing interference cancellation based on the metric values of the interfering cells and the predefined order of interference cancellation, when the interference cancellation unit performs interference cancellation on interference on CRSs of the interfering cells, different channel estimation methods are used to respectively estimate interfering cell CRS channels for the cases where a metric value is greater than or equal to a second threshold value and less than the second threshold value.

Supplement 10. The apparatus according to supplement 8, wherein,

the channel estimating unit uses formula (1) to calculate the LS channel estimation;

the first power calculating unit uses formula (6) to calculate the interference and noise power of the interfering cells;

the second power calculating unit uses formula (10) to calculate the LS signal power of the interfering cells;

and the metric value calculating unit uses formula (13) or (14) to calculate the SINR.

Supplement 11. A receiver, comprising the apparatus as described in any one of supplements 140.

Supplement 12. An interference cancellation method, comprising:

seriatim performing interference cancellation on interference on common reference signals (CRSs) of interfering cells in each granularity based on preset granularities; wherein in performing interference cancellation on the interference on the CRSs of the interfering cells in each granularity, the interference cancellation is performed based on metric values of the interfering cells and/or a predetermined order of interference cancellation; and wherein the granularities denote a whole bandwidth or a part of the whole bandwidth, the number of corresponding granularities is N, N being an integer greater than or equal to 1, and the interfering cells are neighboring cells having interference on the serving cell to which a receiver belongs.

Supplement 13. The method according to supplement 12, wherein for each granularity, performing the interference cancellation based on metric values of the interfering cells comprises:

calculating metric values of the interfering cells according to receiving signals at CRS resource elements of the interfering cells; and

performing interference cancellation on interference on the CRSs of the interfering cells according to the metric values obtained through calculation.

Supplement 14. The method according to supplement 13, wherein for each granularity, the performing interference cancellation on interference on the CRSs of the interfering cells according to the metric values obtained through calculation comprises: performing interference cancellation on interference on the CRSs of the interfering cells in a descending order of the metric values.

Supplement 15. The method according to supplement 13 or 14, wherein the performing interference cancellation on interference on the CRSs of the interfering cells according to the metric values obtained through calculation comprises: performing CRS interference cancellation on the interfering cells to which the metric values greater than the first threshold value correspond.

Supplement 16. The method according to supplement 13 or 14 or 15, wherein the performing interference cancellation on interference on the CRSs of the interfering cells according to the metric values obtained through calculation comprises:

performing interference cancellation on interference on CRSs of the interfering cell to which the current maximum metric value corresponds;

judging whether the CRS positions in the interfering cells without being performed interference cancellation collide with those of the interfering cell to which the current maximum metric value corresponds having been performed interference cancellation on interference on the CRSs; and

when the judgment result is that there is no colliding CRS position, performing interference cancellation on interference on the CRSs of the interfering cells without being performed interference cancellation to which maximum metric value except the current maximum metric value correspond.

Supplement 17. The method according to supplement 16, wherein when the judgment result is that there are colliding CRS positions, the method further comprises:

recalculating metric values of the interfering cells without being performed interference cancellation having CRS positions colliding with those of the interfering cells having been performed interference cancellation on interference on the CRSs; and

performing interference cancellation to the CRS interference of the interfering cell to which the maximum metric value in the metric values of the interfering cells having no colliding CRS position and without being performed interference cancellation and the metric values obtained through calculation corresponds.

Supplement 18. The method according to supplement 13, wherein the performing interference cancellation on interference on the CRSs of the interfering cells according to the metric values obtained through calculation comprises:

judging that a calculated metric value is greater than or equal to a second threshold value or less than the second threshold value; and

when interference cancellation is performed on interference on CRSs of the interfering cells, using different channel estimation methods to respectively estimate interfering cell CRS channels for the cases where a metric value is greater than or equal to a second threshold value and less than the second threshold value.

Supplement 19. The method according to supplement 13, wherein for each granularity, the metric value is a signal to interference plus noise ratio (SINR) of the interfering cells, and the calculating the metric value of the interfering cells comprises:

calculating least square (LS) channel estimation at the CRS resource elements of the interfering cells within each granularity;

obtaining interference and noise power of the interfering cells according to the LS channel estimation result;

obtaining LS signal power of the interfering cells according to the LS channel estimation result;

calculating signal power by using the interference and noise power and the LS signal power; and

calculating the metric values according to the obtained interference and noise power and signal power of the interfering cells.

Supplement 20. The method according to supplement 12, wherein for each granularity, when the interference cancellation is performed based on metric values of the interfering cells and/or a predetermined order of interference cancellation, the method further comprises:

determining an order of interference cancellation according to the metric values of the interfering cells.

Supplement 21. The method according to supplement 20, wherein the method further comprises:

in performing interference cancellation based on the metric values of the interfering cells and the predefined order of interference cancellation, when interference cancellation on interference on CRSs of the interfering cells is performed, using different channel estimation methods to respectively estimate interfering cell CRS channels for the cases where a metric value is greater than or equal to a second threshold value and less than the second threshold value.

Supplement 22. The method according to supplement 19, wherein,

formula (1) is used to calculate the LS channel estimation;

formula (6) is used to calculate the interference and noise power of the interfering cells;

formula (10) is used to calculate the LS signal power of the interfering cells;

formula (13) or (14) is used to calculate the SINR.

The above apparatuses and methods of the present invention may be implemented by hardware, or by hardware in combination with software. The present invention relates to such a computer-readable program that when the program is executed by a logic device, the logic device is enabled to carry out the apparatus or components as described above, or to carry out the methods or steps as described above. The present invention also relates to a storage medium for storing the above program, such as a hard disk, a floppy disk, a CD, a DVD, and a flash memory, etc.

The present invention is described above with reference to particular embodiments. However, it should be understood by those skilled in the art that such a description is illustrative only, and not intended to limit the protection scope of the present invention. Various variants and modifications may be made by those skilled in the art according to the spirits and principle of the present invention, and such variants and modifications fall within the scope of the present invention.

1. An interference cancellation apparatus, comprising:
an interference cancellation unit configured to, based on preset granularities, seriatim perform interference cancellation on interference on common reference signals (CRSs) of interfering cells in each granularity; wherein in performing interference cancellation on the interference on the CRSs of the interfering cells in each granularity, the interference cancellation is performed based on metric values of the interfering cells and/or a predetermined order of interference cancellation; and wherein the granularities denote a whole bandwidth or a part of the whole bandwidth, the number of corresponding granularities is N, N being an integer greater than or equal to 1, and the interfering cells are neighboring cells having interference on the serving cell to which a receiver belongs.

2. The apparatus according to claim 1, wherein for each granularity, in performing the interference cancellation based on metric values of the interfering cells, the interference cancellation unit comprises:
a first calculating unit configured to calculate metric values of the interfering cells according to receiving signals at CRS resource elements of the interfering cells; and
a first processing unit configured to perform interference cancellation on interference on the CRSs of the interfering cells according to the metric values obtained by the first calculating unit through calculation.

3. The apparatus according to claim 2, wherein for each granularity, the first calculating unit is further configured to perform interference cancellation on interference on the CRSs of the interfering cells in a descending order of the metric values.

4. The apparatus according to claim 2, wherein the first calculating unit is further configured to take the interfering cells to which metric values greater than a first threshold value correspond as the interfering cells on the CRSs of which interference cancellation is performed.

5. The apparatus according to claim 2, wherein the first processing unit comprises:
a first interference canceling unit configured to perform interference cancellation on interference on CRSs of the interfering cell to which the current maximum metric value corresponds;
a first judging unit configured to judge whether the CRS positions in the interfering cells without being performed interference cancellation collide with those of the interfering cell to which the current maximum metric value corresponds having been performed interference cancellation on interference on the CRSs; and
a second interference canceling unit configured to, when the judgment result of the first judging unit is that there is no colliding CRS position, perform interference cancellation on interference on the CRSs of the interfering cells without being performed interference cancellation to which maximum metric value except the current maximum metric value correspond.

6. The apparatus according to claim 5, wherein the first processing unit further comprises:
a second calculating unit configured to, when the judgment result of the first judging unit is that there are colliding CRS positions, recalculate metric values of the interfering cells without being performed interference cancellation having CRS positions colliding with those of the interfering cells having been performed interference cancellation on interference on the CRSs;
and the first interference canceling unit is further configured to perform interference cancellation to the CRS interference of the interfering cell to which the maximum metric value in the metric values of the interfering cells having no colliding CRS position and without being performed interference cancellation and the metric values obtained by the second calculating unit through calculation corresponds.

7. The apparatus according to claim 2, wherein the first processing unit comprises:
a second judging unit configured to judge a calculated metric value is greater than or equal to a second threshold value or less than the second threshold value; and
a third interference canceling unit configured to, when interference cancellation is performed on interference on CRSs of the interfering cells, use different channel estimation methods to respectively estimate interference cell CRS channels for the cases where a metric value is greater than or equal to a second threshold value and less than the second threshold value.

8. The apparatus according to claim 2, wherein for each granularity, the metric value is a signal to interference plus noise ratio of the interfering cells, and the first calculating unit comprises:
a channel estimating unit configured to calculate least square (LS) channel estimation at the CRS resource element of the interfering cells within each granularity;
a first power calculating unit configured to obtain interference and noise power of the interfering cells according to the LS channel estimation result;
a second power calculating unit configured to obtain LS signal power of the interfering cells according to the LS channel estimation result;
a signal power calculating unit configured to calculate signal power by using the interference and noise power calculated by the first power calculating unit and the LS signal power calculated by the second power calculating unit; and
a metric value calculating unit configured to calculate the metric values according to the obtained interference and noise power and signal power of the interfering cells.

9. The apparatus according to claim 1, wherein for each granularity, when the interference cancellation is performed based on metric values of the interfering cells and/or a predetermined order of interference cancellation, the apparatus further comprises:
a setting unit configured to determine an order of interference cancellation according to the metric values of the interfering cells.

10. A receiver, comprising the apparatus as claimed in claim 1.

11. An interference cancellation method, comprising:
seriatim performing interference cancellation on interference on common reference signals (CRSs) of interfering cells in each granularity based on preset granularities; wherein in performing interference cancellation on the interference on the CRSs of the interfering cells in each granularity, the interference cancellation is performed based on metric values of the interfering cells and/or a predetermined order of interference cancellation; and wherein the granularities denote a whole bandwidth or a part of the whole bandwidth, the number of corresponding granularities is N, N being an integer greater than or equal to 1, and the interfering cells are neighboring cells having interference on the serving cell to which a receiver belongs.

12. The method according to claim 11, wherein for each granularity, performing the interference cancellation based on metric values of the interfering cells comprises:
calculating metric values of the interfering cells according to receiving signals at CRS resource elements of the interfering cells; and
performing interference cancellation on interference on the CRSs of the interfering cells according to the metric values obtained through calculation.

13. The method according to claim 12, wherein for each granularity, the performing interference cancellation on interference on the CRSs of the interfering cells according to the metric values obtained through calculation comprises: performing interference cancellation on interference on the CRSs of the interfering cells in a descending order of the metric values.

14. The method according to claim 12, wherein the performing interference cancellation on interference on the CRSs of the interfering cells according to the metric values obtained through calculation comprises: performing CRS interference cancellation on the interfering cells to which the metric values greater than the first threshold value correspond.

15. The method according to claim 12, wherein the performing interference cancellation on interference on the CRSs of the interfering cells according to the metric values obtained through calculation comprises:
performing interference cancellation on interference on CRSs of the interfering cell to which the current maximum metric value corresponds;
judging whether the CRS positions in the interfering cells without being performed interference cancellation collide with those of the interfering cell to which the current maximum metric value corresponds having been performed interference cancellation on interference on the CRSs; and
when the judgment result is that there is no colliding CRS position, performing interference cancellation on interference on the CRSs of the interfering cells without being performed interference cancellation to which maximum metric value except the current maximum metric value correspond.

16. The method according to claim 15, wherein when the judgment result is that there are colliding CRS positions, the method further comprises:
recalculating metric values of the interfering cells without being performed interference cancellation having CRS positions colliding with those of the interfering cells having been performed interference cancellation on interference on the CRSs; and
performing interference cancellation to the CRS interference of the interfering cell to which the maximum metric value in the metric values of the interfering cells having no colliding CRS position and without being performed interference cancellation and the metric values obtained through calculation corresponds.

17. The method according to claim 12, wherein the performing interference cancellation on interference on the CRSs of the interfering cells according to the metric values obtained through calculation comprises:
judging that a calculated metric value is greater than or equal to a second threshold value or less than the second threshold value; and
when interference cancellation is performed on interference on CRSs of the interfering cells, using different channel estimation methods to respectively estimate interfering cell CRS channels for the cases where a metric value is greater than or equal to a second threshold value and less than the second threshold value.

18. The method according to claim 12, wherein for each granularity, the metric value is a signal to interference plus noise ratio (SINR) of the interfering cells, and the calculating the metric value of the interfering cells comprises:
calculating least square (LS) channel estimation at the CRS resource elements of the interfering cells within each granularity;
obtaining interference and noise power of the interfering cells according to the LS channel estimation result;
obtaining LS signal power of the interfering cells according to the LS channel estimation result;
calculating signal power by using the interference and noise power and the LS signal power; and
calculating the metric values according to the obtained interference and noise power and signal power of the interfering cells.

19. The method according to claim 11, wherein for each granularity, when the interference cancellation is performed based on metric values of the interfering cells and/or a predetermined order of interference cancellation, the method further comprises:
determining an order of interference cancellation according to the metric values of the interfering cells.

20. The method according to claim 19, wherein the method further comprises:
in performing interference cancellation based on the metric values of the interfering cells and the predefined order of interference cancellation, when interference cancellation on interference on CRSs of the interfering cells is performed, using different channel estimation methods to respectively estimate interfering cell CRS channels for the cases where a metric value is greater than or equal to a second threshold value and less than the second threshold value.
